(19) United States
(12) Patent Application Publication
(10) Pub. No.: US 2012/0006626 A1
(43) Pub. Date: Jan. 12, 2012

(54) ELEVATOR SYSTEM INCLUDING MULTIPLE CARS WITHIN A SINGLE HOISTWAY

(75) Inventor: Leandre Adifon, Farmington, CT (US)

(73) Assignee: OTIS ELEVATOR COMPANY, Farmington, CT (US)

(21) Appl. No.: 13/257,615

(22) PCT Filed: Apr. 29, 2009
(86) PCT No.: PCT/US2009/042078

§ 371 Date: Sep. 20, 2011

(51) Int. Cl. B66B 9/00; B66B 11/08

(52) U.S. Cl. 187/249

(57) ABSTRACT

An elevator system includes first and second elevator cars and counterweights within a hoistway. A first load bearing assembly supports the first elevator car and counterweight and follows a path between a first end supported in a fixed position, at least partially around a first car sheave, at least partially around another sheave separate from the first elevator car and counterweight, at least partially around a first counterweight sheave, and to a second end supported in a fixed position. A second load bearing assembly supports the second elevator car and counterweight and follows a path between a first end supported in a fixed position, at least partially around two second car sheaves, at least partially around another sheave separate from the second elevator car and counterweight, at least partially around a second counterweight sheave to a second end supported in a fixed position.

### BACKGROUND

Elevator systems typically include a single elevator car that is movable within a hoistway for carrying passengers between different levels in a building, for example. A variety of elevator system configurations are known for addressing particular needs in particular situations. One suggestion for increasing elevator system capacity without requiring an increased amount of building space is to include more than one elevator car within a single hoistway.

Another space-savings approach is to eliminate the separate machine room that was typically positioned above an elevator hoistway. Machine roomless elevator systems have been proposed in a variety of configurations.

While using approaches such as including multiple cars within a single hoistway and eliminating the requirement for a machine room present cost saving possibilities, there are additional challenges introduced such as being able to configure the elevator system components for optimum system operation. For example, it is necessary to arrange the roping for suspending both elevator cars in a manner that will not inhibit the movement of either car or its associated counterweight.

### SUMMARY

An exemplary elevator system includes a first elevator car that is movable within a hoistway. A first counterweight is also movable within the hoistway. A second elevator car is movable within the hoistway and is below the first elevator car. The second counterweight, which is above the first counterweight, is movable within the same hoistway. A first load bearing assembly supports the first elevator car and the first counterweight. The first load bearing assembly follows a path between a first end supported in a fixed position, at least partially around a first car sheave that moves with the first elevator car, at least partially around at least one sheave separate from the first elevator car, past one side of the second counterweight, at least partially around a first counterweight sheave that moves with the first counterweight, and past another side of the second counterweight to a second end supported in a fixed position. A first machine is associated with one of the sheaves along the path followed by the first load bearing assembly. The first machine selectively causes movement of the first load bearing assembly to control the position and movement of the first elevator car. A second load bearing assembly supports the second elevator car and the second counterweight. The second load bearing assembly follows a path between a first end supported in a fixed position, at least partially around two second car sheaves that move with the second elevator car, at least partially around a sheave separate from the second elevator car and the second counterweight, at least partially around a second counterweight sheave that moves with the second counterweight to a second end supported in a fixed position. A second machine is associated with one of the sheaves along the path followed by the second load bearing assembly. The second machine selectively causes movement of the second load bearing assembly to control the position and movement of the second elevator car.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an example elevator system.

FIG. 2 schematically illustrates an alternative arrangement of selected portions of the embodiment of FIG. 1.

FIG. 3 schematically illustrates an example arrangement of selected portions of the embodiment of FIG. 1.

FIG. 4 schematically illustrates an example arrangement of selected portions of the embodiment of FIG. 1.

FIG. 5 schematically illustrates an example arrangement of selected portions of the embodiment of FIG. 1.

### DETAILED DESCRIPTION

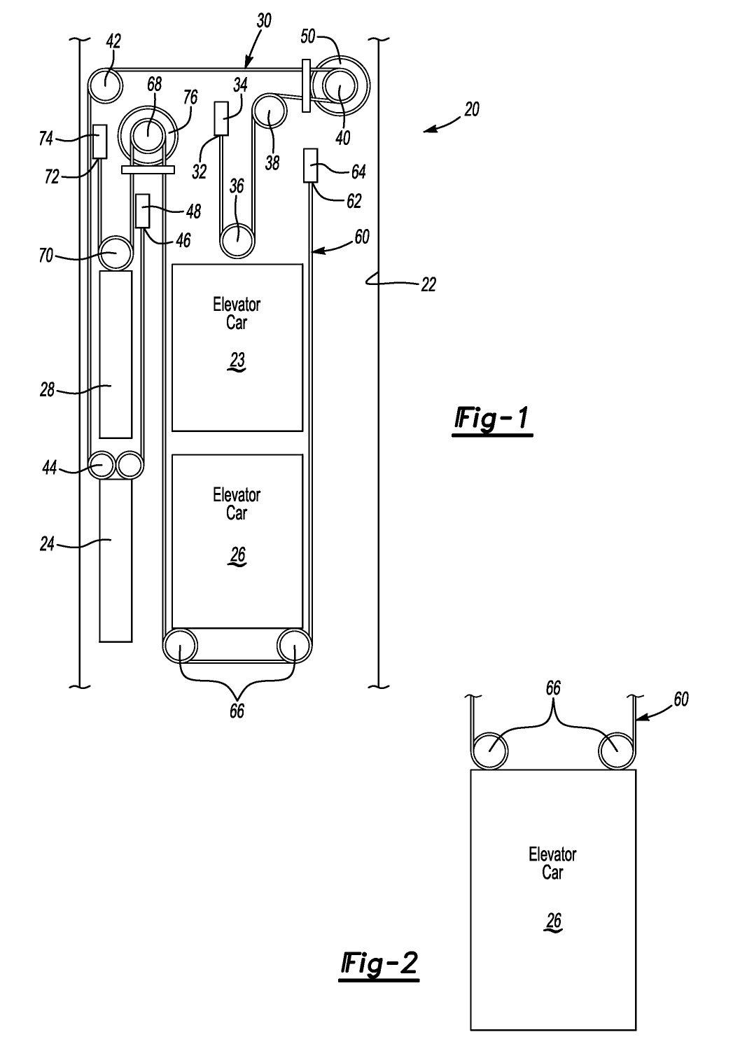

FIG. 1 schematically shows selected portions of an elevator system 20. In this example, multiple elevator cars are positioned for movement within a single hoistway 22.

A first elevator car 23 is associated with a first counterweight 24. A second elevator car 26 is associated with a second counterweight 28. The first elevator car 23 is positioned above the second elevator car 26. The second counterweight 28 is positioned above the first counterweight 24.

The illustrated example could include an arrangement of load bearing members (e.g., flat belts or round ropes) for supporting the elevator cars and counterweights so that both are movable within the single hoistway 22.

A first load bearing assembly 30 supports the first elevator car 23 and the first counterweight 24. The first load bearing assembly 30 follows the illustrated path having a first end 32 associated with a termination 34 that remains in a fixed position. In this example, the first end 32 is higher than the first elevator car 23. In this example, the termination 34 is within the hoistway 22. The path followed by the first load bearing assembly 30 goes from the first end 32 at least partially around a first car sheave 36 that is supported for movement with the first elevator car 23 within the hoistway 22. The load bearing assembly 30 follows a path that extends between the first elevator car sheave 36 and at least one sheave separate from the first elevator car 23. In this example, there are three upper sheaves 38, 40 and 42, all positioned higher than the first elevator car 23.

After the first load bearing assembly 30 at least partially wraps around the upper sheave 42, it passes by one side of the second counterweight 28 and then at least partially wraps around a first counterweight sheave 44. In the illustrated example, there are two counterweight sheaves 44 to appropriately space the corresponding portions of the load bearing assembly 30 apart so that the second counterweight 28 is positioned between those portions without any interference that would hinder movement of the second counterweight 28 or the first load bearing assembly 30. A final portion of the path followed by the first load bearing assembly 30 is between the first counterweight sheaves 44 and a second end 46 of the load bearing assembly 30. In this example, the second end 46 is associated with a termination 44 that remains in a fixed position higher than the first counterweight 24. In this example, the termination 48 is supported within the hoistway 22.

A second load bearing assembly 60 supports the second elevator car 26 and the second counterweight 28. A path followed by the second load bearing assembly 60 begins at a first end 62, which in this example remains in a fixed position because it is associated with a termination 64. The first end 62 remains fixed at a location higher than the second elevator car 26 in this example. The path of the second load bearing assembly 60 extends from the first end 62 down to at least partially wrap around two second car sheaves 66 that are supported for movement with the second elevator car 26. In the example of FIG. 1, the car sheaves 66 are positioned beneath the second elevator car 26 in an underslung arrangement.

The path followed by the second load bearing assembly 60 extends between the second car sheaves 66 in an upward direction where the second load bearing assembly 60 at least partially wraps around a sheave 68 separate from the second elevator car 26. In this example the sheave 68 is located higher than the second counterweight 28. The path then continues in a downward direction where the second load bearing assembly 60 at least partially wraps around a second counterweight sheave 70 that moves with the second counterweight 28. The last portion of the path followed by the second load bearing assembly 60 is between the second counterweight sheave 70 and a second end 72 that is associated with a termination 74. In this example, the termination 74 and the second end 72 remain in a fixed position within the hoistway 22 higher than the second counterweight 28.

The example of FIG. 1 allows for using a 2:1 roping arrangement for both of the elevator cars and facilitates an efficient arrangement of elevator system components within the hoistway 22.

A first machine 50 is associated with at least one of the sheaves about which the first load bearing assembly 30 at least partially wraps around. In the example of FIG. 1, the upper sheave 40 is associated with the machine 50. Therefore, the upper sheave 40 is considered a traction sheave in this example. The machine 50 (e.g., motor and brake) control the movement of the traction sheave 40 for controlling the position and movement of the first elevator car 23 within the hoistway 22.

A second machine 76 is associated with at least one of the sheaves about which the second load bearing assembly 60 at least partially wraps around. In this example, the second machine 76 is associated with the upper sheave 68. Therefore, the upper sheave 68 is considered a traction sheave in this example. The second machine 76 (e.g., motor and brake) controls the movement of the traction sheave 68 for controlling the position and movement of the second elevator car 26 within the hoistway 22. The example of FIG. 1 shows a machineroom-less arrangement with the machines 50, 76 located within the hoistway 22.

FIG. 2 schematically shows another arrangement of the second car sheaves 66. In this example, the second car sheave 66 are positioned above the second elevator car 26 in an overslung arrangement. The two second car sheaves are desired for keeping the spacing between portions of the second load bearing assembly 60 far enough apart so that the first elevator car 23 travels between those portions without any interference.

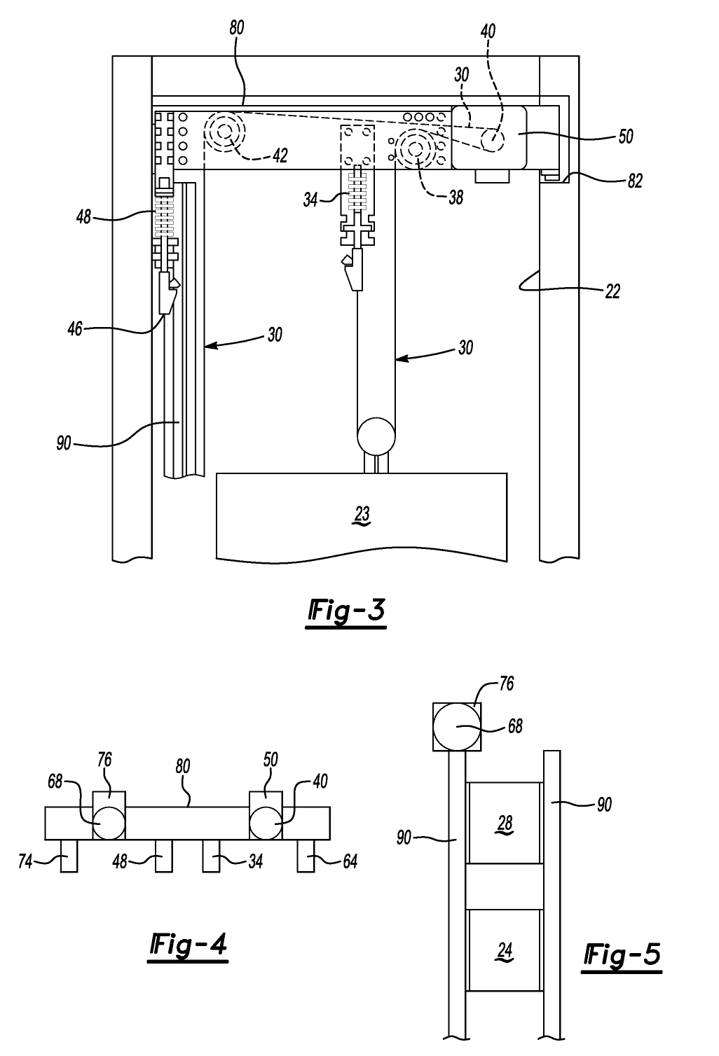

There are a variety of ways in which the first machine 50 and second machine 76 can be supported relative to the hoistway 22. In one example, at least one of the machines is supported on a cassette structure. One such example is shown in FIG. 3. In the illustration, the first machine 50 is supported on a cassette structure 80 that is supported at least partially by a surface 82 associated with a hoistway wall of the hoistway 22. In one example, the cassette structure comprises metal beams that are pre-assembled together prior to delivery at the site of the hoistway 22. The cassette structure 80 allows for realizing a machine roomless arrangement in which the first machine 50 may be positioned within the hoistway 22. As can be appreciated from the drawing, the cassette structure 80 supports the first machine 50, the traction sheave 40, the upper sheaves 38 and 42 and the terminations 34 and 48.

FIG. 4 schematically shows another cassette structure 80. In this example, the first machine 50, traction sheave 40 and the terminations 34 and 48 are all supported by the cassette structure 80. The same cassette structure 80 supports the second machine 76, the traction sheave 68, the termination 64 and the termination 74. In the example of FIG. 4, both of the machines are supported on a cassette structure that may be conveniently located within the confines of the hoistway 22.

FIG. 5 schematically illustrates an arrangement where at least one of the machines is supported near a top of a guiderail within the hoistway 22. In the example of FIG. 5, one of the counterweight guiderails 90 supports the second machine 76. It is possible to have both of the machines 50 and 76 supported near the top of a guiderail within the hoistway 22. It is also possible to have one of the machines supported on a cassette structure with the other of the machines supported on a guiderail.

Another feature of the illustration of FIG. 5 is that both counterweights 24 and 28 share a single set of counterweight guiderails 90. This increases efficiencies in terms of materials, installation and space.

In one example, the space that would be used for a machine room is used as a parking space for the first elevator car 23 when the second elevator car has to service the top floor landing. The machines 50 and 76 and one or more of the terminations may be positioned within the space that might otherwise be a machine room in such an example.

The illustrated example provides a unique arrangement of elevator system components for operating two elevator cars within a single hoistway.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. An elevator system, comprising:
a first elevator car that is movable within a hoistway;
a first counterweight that is movable within the hoistway;
a second elevator car that is movable within the hoistway, the second elevator car being below the first elevator car;
a second counterweight that is movable within the hoistway, the second counterweight being above the first counterweight;
a first load bearing assembly that supports the first elevator car and the first counterweight, the first load bearing assembly following a path between a first end supported in a fixed position, at least partially around a first car sheave that moves with the first elevator car, at least partially around at least one sheave separate from the first elevator car and the first counterweight, past one side of the second counterweight, at least partially around a first counterweight sheave that moves with the first counterweight, and past another side of the second counterweight to a second end supported in a fixed position;
a first machine associated with one of the sheaves along the path followed by the first load bearing assembly, the first machine selectively causing movement of the first load bearing assembly to control the position and movement of the first elevator car;
a second load bearing assembly that supports the second elevator car and the second counterweight, the second load bearing assembly following a path between a first end supported in a fixed position, at least partially around two second car sheaves that move with the second elevator car, at least partially around a sheave separate from the second elevator car and the second counterweight, at least partially around a second counterweight sheave that moves with the second counterweight to a second end supported in a fixed position; and
a second machine associated with one of the sheaves along the path followed by the second load bearing assembly, the second machine selectively causing movement of the second load bearing assembly to control the position and movement of the second elevator car.

2. The elevator system of claim 1, wherein the first machine is associated with the at least one sheave separate from the first elevator car and the first counterweight and the at least one sheave is a traction sheave.

3. The elevator system of claim 2, wherein the first machine is supported near a top of a guiderail.

4. The elevator system of claim 2, wherein the first machine is supported by a cassette structure above the first elevator car.

5. The elevator system of claim 2, wherein the second machine is associated with the sheave separate from the second elevator car and the second counterweight.

6. The elevator system of claim 5, wherein the first and second machines are supported near tops of respective guide rails.

7. The elevator system of claim 5, wherein the first machine and second machine are supported on a cassette structure above the elevator cars and counterweights.

8. The elevator system of claim 5, wherein one of the first machine or the second machine is supported near a top of a guide rail and the other of the first machine or the second machine is supported on a cassette structure above the elevator cars and counterweights.

9. The elevator system of claim 1, comprising two guide rails and wherein the first counterweight and the second counterweight are both guided along the two guide rails.

10. The elevator system of claim 1, wherein the two second car sheaves are supported beneath the second elevator car.

11. The elevator system of claim 1, wherein the two second car sheaves are supported above the second elevator car.
